(19) United States
(12) Patent Application Publication
(10) Pub. No.: US 2025/0379354 A1
(43) Pub. Date: Dec. 11, 2025

(54) ANTENNA AND COMMUNICATION DEVICE

(71) Applicant: Huawei Technologies Co., Ltd., Shenzhen (CN)

(72) Inventors: Xijie Chen, Chengdu (CN); Mingyang Li, Chengdu (CN); Shuchen Zhao, Chengdu (CN); Fulong Chen, Chengdu (CN)

(21) Appl. No.: 19/310,389

(22) Filed: Aug. 26, 2025

Related U.S. Application Data
(63) Continuation of application No. PCT/CN2023/137982, filed on Dec. 11, 2023.

(30) Foreign Application Priority Data
Feb. 27, 2023 (CN) 202310209389.X

(51) Int. Cl. H01Q 1/52; H01Q 1/36; H01Q 1/48; H01Q 21/28

(52) U.S. Cl. CPC H01Q 1/521; H01Q 1/36; H01Q 1/48; H01Q 21/28

(57) ABSTRACT

An antenna provided in this application may include a first element, a second element, a decoupling stub, a first parasitic structure, and a second parasitic structure. The decoupling stub is connected to the first element and the second element, there is a first gap between the decoupling stub and the first element, there is a second gap between the decoupling stub and the second element, the first parasitic structure is disposed in the first gap, and the second parasitic structure is disposed in the second gap.

### CROSS-REFERENCE TO RELATED APPLICATIONS

This application is a continuation of International Application No. PCT/CN2023/137982, filed on Dec. 11, 2023, which claims priority to Chinese Patent Application No. 202310209389.X, filed on Feb. 27, 2023. The disclosures of the aforementioned applications are hereby incorporated by reference in their entireties.

### TECHNICAL FIELD

This application relates to the field of communication technologies, and in particular, to an antenna and a communication device.

### BACKGROUND

With continuous development of communication technologies, a requirement of a user for using a wireless network is also increasing rapidly. In indoor application scenarios, indoor digitalization is a current development trend of mobile interconnection. In indoor space, a small base station is usually deployed due to a limitation of a space size. The small base station is featured in low power and a small size. With development of a mobile communication system to a 5th generation (5G) mobile communication technology, a communication capacity requirement of the user on an indoor wireless network is further improved. Therefore, the indoor small base station needs to meet a requirement for a larger communication capacity by increasing a quantity of transmit channels and a quantity of receive channels. Due to a limitation of a size of the entire small base station, a quantity of antennas that can be built in space is close to an upper limit. If more antennas are added, a spacing between the antennas cannot be effectively ensured. As a result, coupling between the antennas is too strong, isolation becomes poor, and overall performance cannot reach an expected gain. In addition, costs of the entire small base station increase linearly as the quantity of antennas increases, and more antennas indicate higher costs. This affects commercial application of the small base station.

A dual-port antenna can provide two antenna ports in a small size (for example, in a size of one antenna), which is equivalent to two antennas. Therefore, using the dual-port antenna in the small base station can effectively reduce the quantity of antennas and the costs, and can also ensure overall performance of the small base station.

However, in a current dual-port antenna, problems of poor isolation and narrow decoupling bandwidth still exist. Therefore, it is not conducive to ensuring performance of the small base station.

### SUMMARY

This application provides an antenna and a communication device that have good isolation and can effectively expand a decoupling bandwidth.

According to a first aspect, this application provides an antenna. The antenna may include a first element, a second element, a decoupling stub, a first parasitic structure, and a second parasitic structure. A first end of the decoupling stub is connected to the first element, and a second end of the decoupling stub is connected to the second element. There is a first gap between the decoupling stub and the first element, and there is a second gap between the decoupling stub and the second element. The first parasitic structure is disposed in the first gap, and the second parasitic structure is disposed in the second gap. When the first element and the second element operate, coupling may be generated between the first element and the second element, and an initial coupling current is generated. In addition, a conduction current is also formed in the decoupling stub. The conduction current can be cancelled out with the initial coupling current, to generate one isolation null (for example, a frequency at which an S21 parameter between two antenna feed ports is close to 0). This can effectively improve isolation between the first element and the second element. In addition, there is a first gap between the decoupling stub and the first element, and there is a second gap between the decoupling stub and the second element. The first parasitic structure is disposed in the first gap, and the second parasitic structure is disposed in the second gap. When the first element and the second element operate, a coupling current may be generated in the first parasitic structure and the second parasitic structure, and the coupling current can be cancelled out with the initial coupling current, to generate another isolation null. This can effectively improve isolation between the first element and the second element. Under a joint effect of the decoupling stub, the first parasitic structure, and the second parasitic structure, the antenna can generate two isolation nulls. This helps ensure performance of the antenna and broadband decoupling performance.

In an example, a length of the decoupling stub may be any value in 0.1 λ to 0.4 λ, and a width of the decoupling stub may be any value in 0.2 millimeter (mm) to 4 mm, so that decoupling effect generated by the decoupling stub can be effectively improved. λ is a wavelength corresponding to a lowest frequency within a relative operating frequency band range of the antenna.

In an example, a width of the first gap or the second gap may be any value in 0.01 λ to 0.15 λ, so that decoupling effect generated by the first parasitic structure and the second parasitic structure can be effectively improved. λ is a wavelength corresponding to a lowest frequency within a relative operating frequency band range of the antenna.

In an example, the first parasitic structure includes at least one U-shaped parasitic body, and the second parasitic structure includes at least one U-shaped parasitic body. In specific application, a quantity and a position layout of U-shaped parasitic bodies may be appropriately adjusted based on an actual requirement, so that flexibility is good.

In an example, the first element and the second element are located in a rectangular contour, the first element is located at a first corner in the rectangular contour, the second element is located at a second corner in the rectangular contour, and the first corner and the second corner are diagonally opposite. The first element has a first feed point, and the first feed point is located in a first region of the first element, where the first region is a region whose circle center is the first corner and diameter is a largest axis of the first element. The second element has a second feed point, and the second feed point is located in a second region of the second element, where the second region is a region whose circle center is the second corner and diameter is a largest axis of the second element. The first element is located at the first corner in the rectangular contour, and the second element is located at the second corner in the rectangular contour, so that there is a sufficient distance between the first element and the second element. In addition, areas of regions in which the first element and the second element are located is small. This helps decrease an area of the antenna. In addition, a distance between a first feed point and a second feed point may be set to be long, to improve isolation between the first element and the second element.

In an example, the first element has a first ground point, and the first ground point is located in a first region of the first element, where the first region is a region whose circle center is the first corner and diameter is a largest axis of the first element. The second element has a second ground point, and the second ground point is located in a second region of the second element, where the second region is a region whose circle center is the second corner and diameter is a largest axis of the second element. According to the foregoing position layout, a long distance between the first ground point and the second ground point may be set, to improve the isolation between the first element and the second element.

In an example, the antenna further includes a first feed line, a second feed line, and a third parasitic structure. The first feed line is in feed connection to the first element, the second feed line is in feed connection to the second element, and there is a third gap between the first feed line and the second feed line. The third parasitic structure is located in the third gap. When the first element and the second element operate, coupling may be generated between the first element and the second element, and an initial coupling current is generated. The third parasitic structure is located in a gap between the first feed line and the second feed line. Therefore, a coupling current may be generated in the third parasitic structure. The coupling current can be cancelled out with the initial coupling current, to generate another isolation null. This can effectively improve the isolation between the first element and the second element.

In addition, under a joint effect of the decoupling stub, the first parasitic structure, the second parasitic structure, and the third parasitic structure, the antenna can generate three isolation nulls, to expand a decoupling bandwidth. This helps ensure performance of the antenna and broadband decoupling performance.

During specific disposing, the third parasitic structure may include at least one U- shaped parasitic body. In specific application, a quantity, sizes, and a position layout of U- shaped parasitic bodies may be appropriately adjusted based on an actual requirement, so that flexibility is good.

In specific implementation, the antenna may include a first board body, a second board body, a third board body, and a fourth board body. The first board body and the second board body are spaced apart from each other in parallel, and the third board body and the fourth board body are connected between the first board body and the second board body. The first element, the second element, the decoupling stub, the first parasitic structure, and the second parasitic structure are all located on the first board body. The first feed line, the second feed line, and the third parasitic structure are all located on the second board body. The third board body has a first feed connection line, one end of the first feed connection line is connected to the first feed line, and the other end of the first feed connection line is connected to the first element. The fourth board body has a second feed connection line, one end of the second feed connection line is connected to the second feed line, and the other end of the second feed connection line is connected to the second element.

In an example, the first board body, the second board body, the third board body, and the fourth board body may be printed circuit boards (PCBs), or may be flexible circuit boards (FPC) boards. Alternatively, in some examples, the antenna may be a metal structure like a sheet metal part having a specific shape. This is not limited in this application.

According to a second aspect, this application further provides a communication device, including a baseband unit, a radio HUB, and one or more of the foregoing antennas. The baseband unit is connected to the radio HUB, and the plurality of antennas are all connected to the radio HUB. Through application of the foregoing antenna, a miniaturization design of the communication device is easily implemented. In addition, the antenna has good unit performance and broadband decoupling performance. Therefore, it is helpful to ensure implementation of wireless sending and receiving performance of the communication device.

### BRIEF DESCRIPTION OF THE DRAWINGS

FIG. 1 is a block diagram of a structure of an indoor small base station according to an embodiment of this application;

FIG. 2 is a diagram of a structure of an antenna according to an embodiment of this application;

FIG. 3 is an equivalent circuit diagram of the antenna in FIG. 2;

FIG. 4 is a diagram of a model of a decoupling circuit of an antenna according to an embodiment of this application;

FIG. 5 is a diagram of a planar structure of a front side of an antenna according to an embodiment of this application;

FIG. 6 is a diagram of a planar structure of a back side of an antenna according to an embodiment of this application;

FIG. 7 is an equivalent circuit diagram of the antenna in FIG. 6;

FIG. 8 is a diagram of a model of a decoupling circuit of another antenna according to an embodiment of this application;

FIG. 9 is a diagram of a three-dimensional structure of an antenna according to an embodiment of this application;

FIG. 10 is a diagram of a three-dimensional structure of an antenna from another perspective according to an embodiment of this application;

FIG. 11 is a diagram of a three-dimensional structure of a partial structure of an antenna according to an embodiment of this application;

FIG. 12 is an effect diagram of isolation of an antenna according to an embodiment of this application;

FIG. 13 is a directional diagram of an antenna according to an embodiment of this application;

FIG. 14 is a diagram of a three-dimensional structure of a partial structure of another antenna according to an embodiment of this application;

FIG. 15 is a diagram of a structure of a first parasitic structure according to an embodiment of this application;

FIG. 16 is a diagram of a structure of another first parasitic structure according to an embodiment of this application;

FIG. 17 is a diagram of a structure of another first parasitic structure according to an embodiment of this application;

FIG. 18 is a diagram of a structure of another first parasitic structure according to an embodiment of this application;

FIG. 19 is a diagram of a structure of another first parasitic structure according to an embodiment of this application;

FIG. 20 is a diagram of a structure of another first parasitic structure according to an embodiment of this application;

FIG. 21 is a diagram of a structure of another first parasitic structure according to an embodiment of this application;

FIG. 22 is a diagram of a planar structure of a communication device according to an embodiment of this application;

FIG. 23 is a block diagram of a structure of a communication device according to an embodiment of this application; and

FIG. 24 is a block diagram of a structure of another communication device according to an embodiment of this application.

### DETAILED DESCRIPTION OF ILLUSTRATIVE EMBODIMENTS

To make the objectives, technical solutions, and advantages of this application clearer, the following further describes this application in detail with reference to the accompanying drawings.

To facilitate understanding of the antenna provided in embodiments of this application, the following first describes an application scenario of the antenna.

The antenna provided in embodiments of this application may be used in, but is not limited to, a communication device like an indoor small base station, a router, or a ceiling AP (access point). In addition, different antennas may further form an antenna system through networking.

As shown in FIG. 1, an indoor small base station is used as an example. The indoor mini base station may include a baseband unit (BBU), a radio HUB (RHUB), and a pico remote radio unit (pRRU). The antenna may be integrated into the pico remote radio unit. In addition, the pico remote radio unit may further include at least one device like a radio-on-a-chip (ROC), a power supply, a power amplifier, and a filter. The antenna is configured to receive and/or send a radio signal. The radio HUB may be configured to receive downlink baseband data sent by the baseband unit, and transmit the downlink baseband data to the pico remote radio unit after splitting processing, and/or the radio HUB may be configured to perform combination processing on uplink baseband data of the pico remote radio unit, and send processed data to the baseband unit, to implement communication with the baseband unit.

With continuous development of a mobile communication technology, a 5th generation mobile communication technology (5G) is also widely applied. As one of the key technologies of the 5G communication system, a massive multiple-input multiple-output (MIMO) technology can effectively improve a channel capacity. Under the background of a large-scale multiple-input multiple-output technology, a large quantity of antennas need to be arranged in a communication device. In addition, in a miniaturization design, a distance between antennas generally cannot be greater than a half wavelength. That the distance between antennas generally cannot be greater than the half wavelength specifically means that a distance between two adjacent antennas is generally less than or equal to the half wavelength. The wavelength is a wavelength corresponding to a lowest frequency within a relative operating frequency band range of an antenna. When the distance between the antennas is short, electromagnetic coupling between two adjacent antennas is inevitably caused. Electromagnetic coupling between antennas not only increases a power loss of the communication device, but also causes a bad situation like signal distortion. Therefore, decreasing the electromagnetic coupling between the antennas significantly affects improvement of operating performance of the communication device.

A dual-port antenna can provide two antenna ports in a small size (for example, approximately in a size of one antenna), which is equivalent to two antennas. Therefore, using the dual-port antenna in a small base station can effectively reduce a quantity of antennas and costs, and can ensure overall performance of the small base station.

In a current dual-port antenna, there is a significant coupling problem between two ports, and isolation between the two ports cannot be effectively improved. Consequently, performance of the antenna and broadband decoupling performance cannot be ensured.

In view of this, an embodiment of this application provides an antenna that can effectively improve isolation between ports and help expand a decoupling bandwidth.

To make the objectives, technical solutions, and advantages of this application clearer, the following further describes this application in detail with reference to the accompanying drawings and specific embodiments.

Terms used in the following embodiments are merely intended to describe specific embodiments, but are not intended to limit this application. Terms “one”, “a”, and “this” of singular forms used in this specification and the appended claims of this application are also intended to include a form like “one or more”, unless otherwise specified in the context clearly. It may be further understood that, in the following embodiments of this application, “at least one” means one, two, or more.

Reference to “an embodiment” or the like described in this specification means that one or more embodiments of this application include a particular feature, structure, or characteristic described in combination with the embodiment. Therefore, in this specification, statements, such as “in an embodiment”, “in some embodiments”, and “in other embodiments”, that appear at different places do not necessarily refer to a same embodiment. Instead, the statements refer to “one or more but not all of embodiments”, unless otherwise specifically emphasized in another manner. The terms “include”, “have”, and their variants all mean “including but not limited to”, unless otherwise specifically emphasized in another manner.

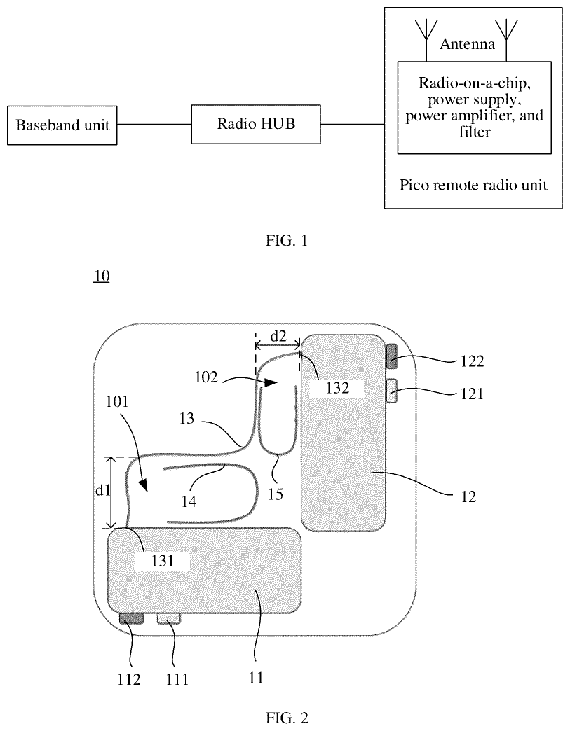

As shown in FIG. 2, an antenna 10 provided in this embodiment of this application may include a first element 11, a second element 12, a decoupling stub 13, a first parasitic structure 14, and a second parasitic structure 15. A first end 131 of the decoupling stub 13 is connected to the first element 11, and a second end 132 of the decoupling stub 13 is connected to the second element 12. In this design, when the first element 11 and the second element 12 operate, coupling may be generated between the first element 11 and the second element 12, and an initial coupling current may be generated. In addition, a conduction current is also formed in the decoupling stub 13. The conduction current can be cancelled out with the initial coupling current, to generate one isolation null. This can effectively improve isolation between the first element 11 and the second element 12. In addition, there is a first gap 101 between the decoupling stub 13 and the first element 11, and there is a second gap 102 between the decoupling stub 13 and the second element 12. The first parasitic structure 14 is disposed in the first gap 101, and the second parasitic structure 15 is disposed in the second gap 102. In this design, the first parasitic structure 14 may be coupled to the first element 11, and the second parasitic structure 15 may be coupled to the second element 12. When the first element 11 and the second element 12 operate, a coupling current may be generated in the first parasitic structure 14 and the second parasitic structure 15, and the coupling current can be cancelled out with the initial coupling current, to generate another isolation null. This can effectively improve isolation between the first element 11 and the second element 12. According to the foregoing design, under a joint effect of the decoupling stub 13, the first parasitic structure 14, and the second parasitic structure 15, the antenna 10 can generate two isolation nulls. This helps ensure performance of the antenna 10 and broadband decoupling performance.

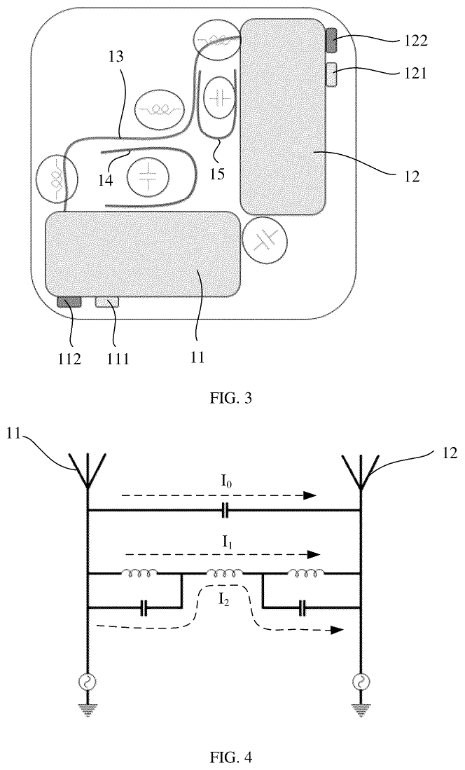

FIG. 3 and FIG. 4 respectively show an equivalent circuit diagram and a diagram of a circuit model of the antenna 10 in FIG. 2.

When a distance between the first element 11 and the second element 12 is short, an initial coupling current I₀ exists, where I₀=A₀(f)e^{jθ}^{₀}^{(f)}, A₀ is an amplitude of the coupling current, f is an operating frequency, θ₀ is a phase of the coupling current, e^{jθ}^{₀}^{(f)}=cos(θ₀(f))+jsin(θ₀(f)), j is an imaginary unit, and j square is equal to −1. A shorter distance between the first element 11 and the second element 12 indicates greater I₀, and a stronger initial coupling current I₀ indicates poorer isolation between two ports of the antenna 10.

In the example provided in this application, to reduce coupling between the first element 11 and the second element 12, a decoupling current path 1 may be introduced. A decoupling current I₁ may be generated on the decoupling current path 1. When I₁ is equal to or approximately equal to A₀(f₁)e^{-jθ}^{₀}^{(f}^{₁}⁾, that is, has an amplitude approximately the same as that of I₀, and has a phase opposite to that of I₀, I₀(f₁)+I₁(f₁) is equal to o or approximately equal to 0. That is, decoupling between the first element 11 and the second element 12 may be implemented near a frequency f₁, to improve isolation of the antenna 10.

In addition, to expand a decoupling bandwidth, another decoupling current path 2 is further added in the example provided in this application. A decoupling current I₂ may be generated on the decoupling current path 2. When I₂ is equal to or approximately equal to A₀(f₂)e^{-jθ}^{₀}^{(f}^{₂}⁾, that is, has an amplitude approximately the same as that of I₀, and has a phase opposite to that of I₀, if I₀(f₂)+I₂(f₂) is equal to 0 or approximately equal to 0, decoupling between the first element 11 and the second element 12 may be implemented near a frequency f₂, to improve isolation of the antenna 10.

In addition, if both f₁ and f₂ are all within an operating frequency band of the antenna 10, a wide decoupling bandwidth may be obtained, so that broadband decoupling performance of the antenna 10 can be effectively improved.

In summary, in the example provided in this application, one conduction current decoupling path may be introduced by using the decoupling stub 13. One coupling current decoupling path may be introduced by using the first parasitic structure 14 and the second parasitic structure 15. Two decoupling resonance frequencies are implemented through the foregoing two decoupling paths.

It should be noted that a conduction decoupling current is a current introduced between the first element 11 and the second element 12 through a directly connected metal or another conductive structure, and a coupling decoupling current is a coupling current generated due to electromagnetic induction when the two antenna 10 elements approach each other through a non-directly connected metal or another conductive structure. The conduction decoupling current I₁ is generated by the decoupling stub 13, and a resonance point is near f₁. The coupling decoupling current I₂ is generated by the first parasitic structure 14 and the second parasitic structure 15, and a resonance point is near f₂.

In actual application, the decoupling stub 13 may be a copper wire or another line structure with good conductivity. Optionally, during disposing, the decoupling stub 13 may be bent close to the first element 11 and the second element 12, to form the first gap 101 and the second gap 102 with uniform width sizes, so that the first parasitic structure 14 and the second parasitic structure 15 can generate an effective decoupling current.

During specific disposing, a length of the decoupling stub 13 may be any appropriate value, for example, any value in 0.1 λ to 0.4 λ. The width of the decoupling stub 13 may be any appropriate value, for example, any value in 0.2 mm to 4 mm, where λ is a wavelength corresponding to a frequency within a relative operating frequency band range of the antenna 10, for example, a wavelength corresponding to a lowest frequency or another frequency within the relative operating frequency band range of the antenna 10. In general, when the antenna 10 operates normally, a generated or received electromagnetic wave is within a specific frequency band range, and a corresponding wavelength during propagation of the electromagnetic wave in space within the frequency band range is λ. During specific disposing, a length size and a width size of the decoupling stub 13 may be appropriately selected and adjusted, to obtain the f₁ required frequency.

In addition, during specific disposing, a width size di of the first gap 101 may be any appropriate value, for example, any value in 0.01 λ to 0.15 λ. A width size d2 of the second gap 102 may be any appropriate value, for example, any value in 0.01 λ to 0.15 λ, where λ is a wavelength corresponding to a frequency within a relative operating frequency band range of the antenna 10, for example, a wavelength corresponding to a lowest frequency or another frequency within the relative operating frequency band range of the antenna 10. In actual application, the required f₂ frequency may be obtained by adjusting values of d1 and d2, and sizes of the first parasitic structure 14 and the second parasitic structure 15. In addition, the required f₂ frequency may further be obtained by adjusting a distance between the first parasitic structure 14 and the decoupling stub 13 and a distance between the first parasitic structure 14 and the first element 11, and adjusting a distance between the second parasitic structure 15 and the decoupling stub 13 and a distance between the second parasitic structure 15 and the second element 12.

In specific application, the foregoing size parameter may be flexibly set based on an actual requirement. Details are not described herein.

In addition, during specific disposing, relative positions of the first element 11 and the second element 12 may be adjusted to improve the isolation between the first element 11 and the second element 12.

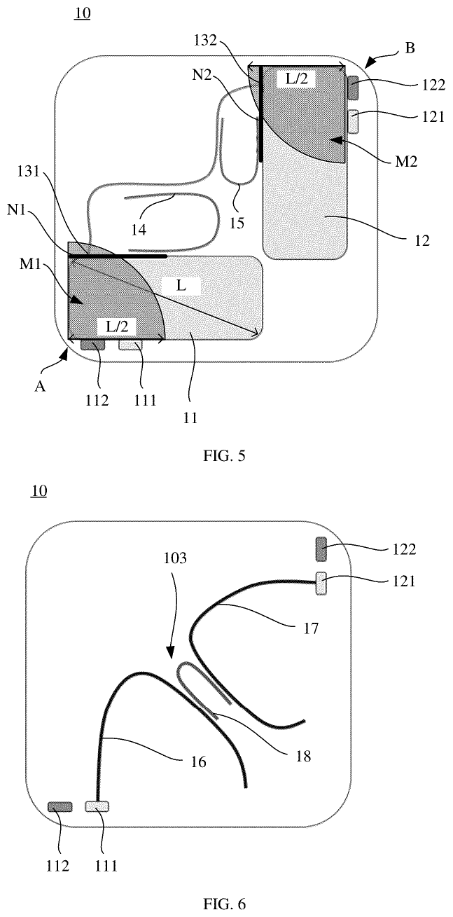

For example, as shown in FIG. 5, in an example provided in this application, both the first element 11 and the second element 12 are approximately rectangular (including square), and the first element 11 and the second element 12 are arranged in an L shape. According to this design, it is ensured that there is a sufficient distance between the first element 11 and the second element 12, and areas of regions in which the first element 11 and the second element 12 are located are small. This helps decrease an area of the antenna 10.

Alternatively, it may be understood that the first element 11 and the second element 12 are located in a same rectangular (including square) contour, and the rectangular contour has a first corner A and a second corner B that are diagonally opposite to each other. A corner of the rectangle may be a right angle, a round angle, or an angle in another possible form. This is not limited. The first element 11 is disposed close to the first corner in the rectangular contour, and the second element 12 is disposed close to the second corner in the rectangular contour.

In addition, during specific disposing, a distance between a first feed point 111 and a second feed point 121 may be set to be long, to improve the isolation between the first element 11 and the second element 12.

For example, as shown in FIG. 5, in an example provided in this application, both the first feed point 111 and the first ground point 112 are located at positions that are on the first element 11 and that are close to the first corner A. Both the second feed point 121 and the second ground point 122 are located at positions that are on the second element 12 and that are close to the second corner B.

During specific disposing, each of a first feed point 111 and a first ground point 112 may be located at any position in a first region M1 of the first element 11. The first region M1 is a region whose circle center is the first corner A and diameter is a largest axis L of the first element 11.

Each of the second feed point 121 and the second ground point 122 may be located at any position in a second region M2 of the second element 12. The second region M2 is a region whose circle center is the second corner B and diameter is a largest axis L of the second element 12.

In specific application, specific positions of the first feed point 111, the first ground point 112, the second feed point 121, and the second ground point 122 may be appropriately selected based on an actual requirement. Details are not described herein.

In addition, it should be noted that, in another example, a shape of the first element 11 or the second element 12 may alternatively be a circle, an ellipse, or another regular or irregular shape. Specific shapes of the first element 11 and the second element 12 are not limited in this application. In addition, in some examples, the first element 11 and the second element 12 may alternatively be monopole antennas, that is, the first ground point 112 and the second ground point 122 may be omitted. In actual application, the types of the first element 11 and the second element 12 may be appropriately selected based on an actual requirement. This is not limited in this application.

In specific application, a position of a connection point between the first element 11 and the decoupling stub 13 may be appropriately set, and a position of a connection point between the second element 12 and the decoupling stub 13 may be appropriately set, to improve the isolation of the antenna 10.

For example, as shown in FIG. 5, in an example provided in this application, the first end 131 of the decoupling stub 13 is connected at a position that is on the first element 11 and that is close to the first feed point 111, and the second end 132 of the decoupling stub 13 is connected at a position that is on the second element 12 and that is close to the second feed point 121.

During specific disposing, the first end 131 of the decoupling stub 13 may be located at any position on a side segment N1 of the first element 11. A length of the side segment N1 is approximately a part of the largest axis L of the first element 11, for example, half, one third, one quarter, or another possible value. This is not limited.

The second end 132 of the decoupling stub 13 may be located at any position on a side segment N2 of the second element 12. A length of the side segment N2 is approximately a part of the largest axis L of the second element 12, for example, half, one third, one quarter, or another possible value. This is not limited.

In specific application, specific connection positions of the first end 131 and the second end 132 of the decoupling stub 13 may be appropriately selected based on an actual requirement. Details are not described herein.

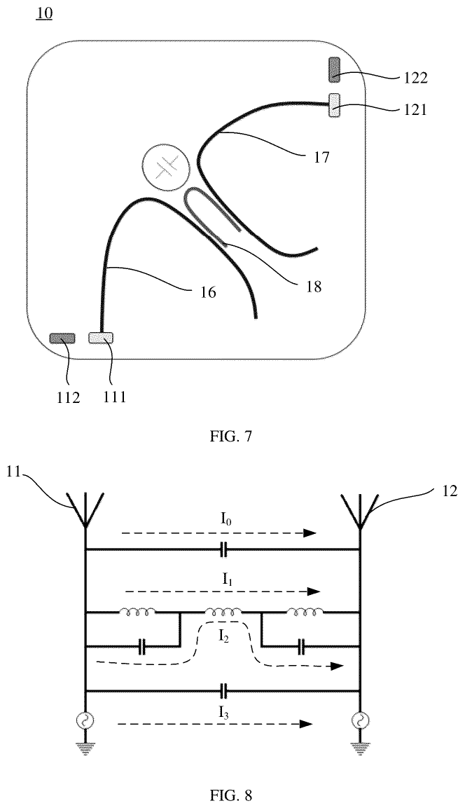

In addition, as shown in FIG. 6 and FIG. 7, in an example provided in this application, the antenna 10 further includes a first feed line 16, a second feed line 17, and a third parasitic structure 18. The first feed line 16 is in feed connection to the first element 11, the second feed line 17 is in feed connection to the second element 12, and there is a third gap 103 between the first feed line 16 and the second feed line 17. The third parasitic structure 18 is located in the third gap 103. In this design, the third parasitic structure 18 may be coupled to the first feed line 16 and the second feed line 17. When the first element 11 and the second element 12 operate, coupling may be generated between the first element 11 and the second element 12, and an initial coupling current is generated. The third parasitic structure 18 is located in a gap between the first feed line 16 and the second feed line 17. Therefore, a coupling current may be generated in the third parasitic structure 18. The coupling current can be cancelled out with the initial coupling current, to generate another isolation null. This can effectively improve the isolation between the first element 11 and the second element 12. In addition, under a joint effect of the decoupling stub 13, the first parasitic structure 14, the second parasitic structure 15, and the third parasitic structure 18, the antenna 10 can generate three isolation nulls. This helps ensure performance of the antenna 10 and broadband decoupling performance.

As shown in FIG. 8, when a distance between the first element 11 and the second element 12 is short, an initial coupling current I₀ exists.

In the example provided in this application, to reduce coupling between the first element 11 and the second element 12, a decoupling current path 1 may be introduced. A decoupling current I₁ may be generated on the decoupling current path 1. When I₁ is equal to or approximately equal to A₀(f₁)e^{-jθ}^{₀}^{(f}^{₁}⁾, that is, has an amplitude approximately the same as that of I₀, and has a phase opposite to that of I₀, I₀(f₁)+I₁(f₁) is equal to o or approximately equal to 0. That is, decoupling between the first element 11 and the second element 12 may be implemented near a frequency f₁, to improve isolation of the antenna 10.

In addition, to expand a decoupling bandwidth, another decoupling current path 2 is further added in the example provided in this application. A decoupling current I₂ may be generated on the decoupling current path 2. When I₂ is equal to or approximately equal to A₀(f₂)e^{-jθ}^{₀}^{(f}^{₂}⁾, that is, has an amplitude approximately the same as that of I₀, and has a phase opposite to that of I₀, I₀(f₂)+I₂(f₂) is equal to 0 or approximately equal to 0. Decoupling between the first element 11 and the second element 12 may be implemented near a frequency f₂, to improve isolation of the antenna 10.

In addition, to expand a decoupling bandwidth, another decoupling current path 3 is further added in the example provided in this application. A decoupling current I₃ may be generated on the decoupling current path 3. When I₃ is equal to or approximately equal to A₀(f₃)e^{-jθ}^{₀}^{(f}^{₃}⁾, that is, has an amplitude approximately the same as that of I₀, and has a phase opposite to that of I₀, I₀(f₃)+I₃(f₃) is equal to 0 or approximately equal to 0. Decoupling between the first element 11 and the second element 12 may be implemented near a frequency f₃, to improve isolation of the antenna 10.

In addition, if f₁, f₂, and f₃ are all within an operating frequency band of the antenna 10, a wide decoupling bandwidth may be obtained, so that broadband decoupling performance of the antenna 10 can be effectively improved.

In summary, in the example provided in this application, one conduction current decoupling path may be introduced by using the decoupling stub 13. Another coupling current decoupling path may be introduced by using the first parasitic structure 14 and the second parasitic structure 15. Another coupling current decoupling path may be introduced by using the third parasitic structure 18. Three decoupling resonance frequencies are implemented through the foregoing three decoupling paths.

It should be noted that, in actual application, the first feed line 16 and the second feed line 17 may be microstrip lines, and impedance matching between the first feed line 16 and the first element 11 may be implemented by adjusting a length size and a width size of the first feed line 16. Alternatively, impedance matching between the first feed line 16 and the first element 11 may be implemented by adding an open stub or a short-circuit stub to the first feed line 16. Correspondingly, impedance matching between the second feed line 17 and the second element 12 may be implemented by adjusting a length size and a width size of the second feed line 17. Alternatively, impedance matching between the second feed line 17 and the second element 12 may be implemented by adding an open stub or a short-circuit stub to the second feed line 17.

Certainly, in another example, the first feed line 16 and the second feed line 17 may alternatively be of a type like a coaxial line or a waveguide. Specific types of the first feed line 16 and the second feed line 17 are not limited in this application.

In actual application, structure types of antenna 10 may be diverse.

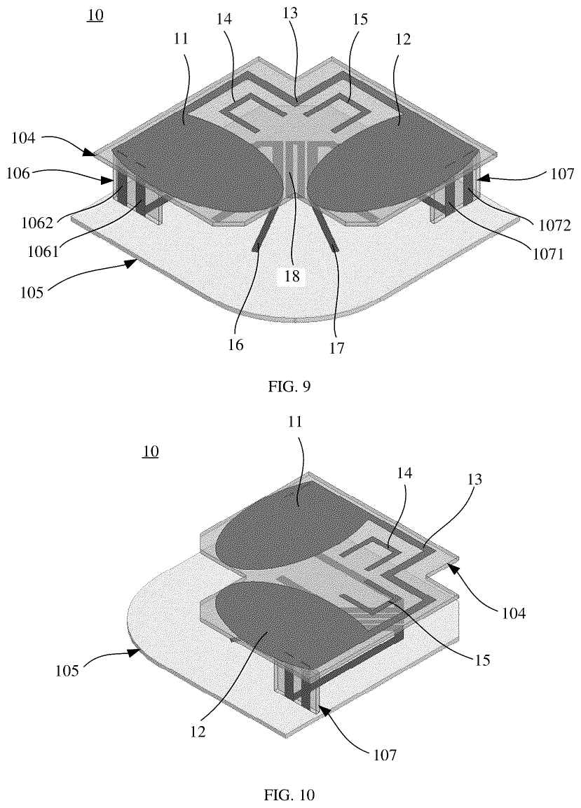

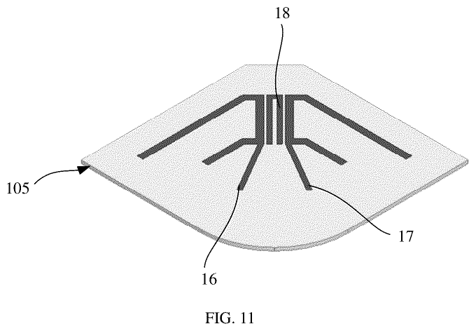

For example, as shown in FIG. 9 to FIG. 11, in an example provided in this application, the antenna 10 is assembled by a plurality of printed circuit boards (printed circuit boards, PCBs).

Specifically, the antenna 10 includes a first board body 104, a second board body 105, a third board body 106, and a fourth board body 107. The first element 11, the second element 12, the decoupling stub 13, the first parasitic structure 14, and the second parasitic structure 15 are all located on the first board body 104. The first feed line 16, the second feed line 17, and the third parasitic structure 18 are all located on the second board body 105. The third board body 106 is connected between the first board body 104 and the second board body 105, and the fourth board body 107 is connected between the first board body 104 and the second board body 105. In an example provided in this application, the first element 11, the second element 12, the decoupling stub 13, the first parasitic structure 14, and the second parasitic structure 15 are all located on a first board surface (for example, an upper board surface in FIG. 9) of the first board body 104. Certainly, in another example, the first element 11, the second element 12, the decoupling stub 13, the first parasitic structure 14, and the second parasitic structure 15 may alternatively be located on different board surfaces of the first board body 104. This is not limited in this application. In addition, the first feed line 16, the second feed line 17, and the third parasitic structure 18 are all located on a first board surface (for example, an upper board surface in FIG. 9) of the second board body 105, and the second board surface (for example, a lower board surface in FIG. 9) of the second board body 105 has a ground plane (not shown in the figure). The first board body 104 is approximately parallel to the second board body 105, the third board body 106 has a first feed connection line 1061 and a first ground line 1062, and the fourth board body 107 has a second feed connection line 1071 and a second ground line 1072. One end of the first ground line 1062 is connected to a ground point of the first element 11, and the other end is connected to a ground plane of the second board body 105. One end of the first feed connection line 1061 is connected to a feed point of the first element 11, and the other end is connected to the first feed line 16 of the second board body 105. Correspondingly, one end of the second ground line 1072 is connected to a ground point of the second element 12, and the other end is connected to a ground plane of the second board body 105. One end of the second feed connection line 1071 is connected to a feed point of the second element 12, and the other end is connected to the second feed line 17 of the second board body 105.

In the foregoing design, a main function of the first board body 104 on which the first element 11 and the second element 12 are located is to radiate a radio signal or receive a radio signal. Therefore, the first element may also be referred to as a first radiator, the second element may also be referred to as a second radiator, and the first board body 104 may also be referred to as a radiation board. A main function of the first feed line 16 and the second feed line 17 is to feed the first element 11 and the second element 12 on the first board body 104. Therefore, the first feed line 16 and the second feed line 17 may also be referred to as a feed network.

In addition, in actual application, the first board body 104, the second board body 105, the third board body 106, and the fourth board body 107 may be printed circuit boards, or may be flexible printed circuit (FPC) boards. This is not limited in this application.

In addition, in another example, the antenna 10 may alternatively be a laminated multilayer board. This is not described herein.

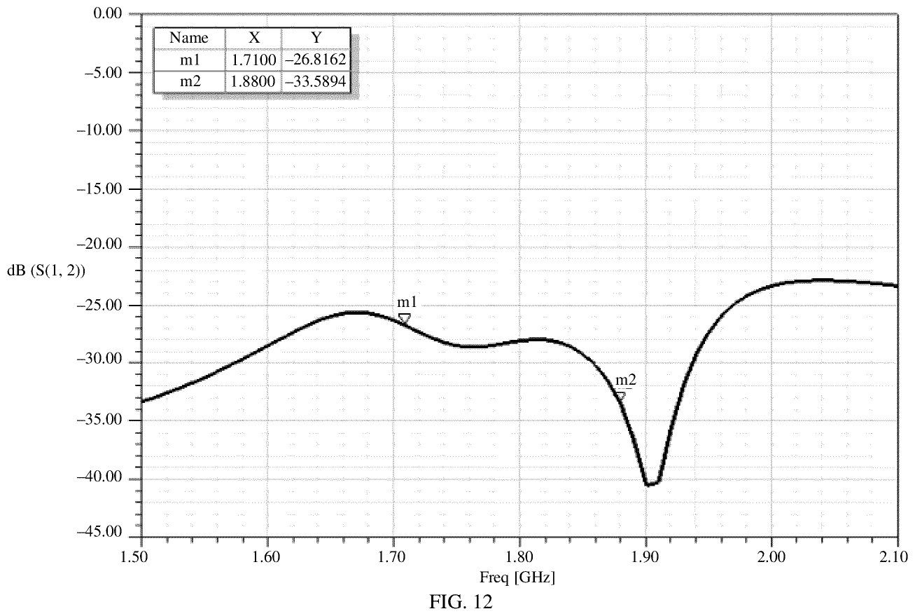

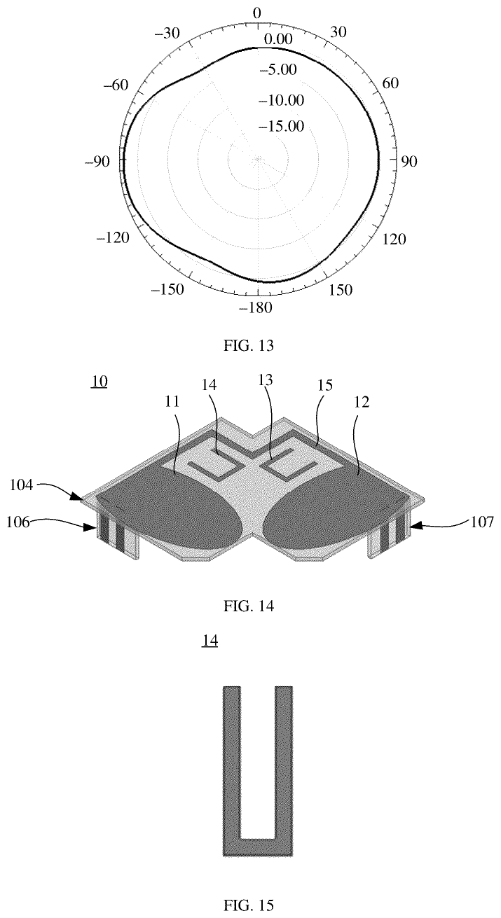

In addition, as shown in FIG. 12 and FIG. 13, an embodiment provided in this application further provides an isolation effect diagram and a directional diagram of the antenna 10 shown in FIG. 9.

Specifically, in FIG. 12, a horizontal coordinate represents a frequency in a unit of GHz, and a vertical coordinate represents isolation in a unit of dB. The operating frequency band of the antenna 10 is 1.8 G (1710 MHz to 1880 MHz), and the isolation between the first element 11 and the second element 12 is shown in FIG. 12. It can be learned that the isolation is greater than 26 dB within the operating frequency band range (1710 MHz to 1880 MHz). In the industry, isolation between two elements generally needs to be greater than 15 dB. It can be learned that, in the antenna 10 provided in this embodiment of this application, there is good isolation between the first element 11 and the second element 12.

In addition, FIG. 13 shows a horizontal plane radiation directional diagram of the first element 11. It can be significantly learned from FIG. 13 that non-circularity (max-min) of a radiation directional diagram of the first element 11 on a horizontal plane is less than 6 dB, and the first element 11 has good radiation omnidirectivity. Therefore, operating performance of the antenna 10 can be ensured.

Optionally, in the example provided in this application, the first element 11 and the second element 12 are basically the same, and characteristics of directional diagrams of the first element 11 and the second element 12 are basically the same. Therefore, for non-circularity of a directional diagram of the second element 12 on a horizontal plane, refer to the figure. Details are not described herein again.

In the foregoing example, the first parasitic structure 14, the second parasitic structure 15, and the third parasitic structure 18 each may be of a U-shaped structure. The parasitic structure may be formed by bending a line body of copper or another conductive material, or may be formed by processing a layer structure of copper or another conductive material by using an etching process. A specific manufacturing process of the parasitic structure is not limited in this application.

A disposition direction of the parasitic structure of the U-shaped structure may be flexibly adjusted based on a requirement.

For example, as shown in FIG. 9 and FIG. 14, the first parasitic structure 14 and the second parasitic structure 15 are used as an example. In FIG. 9, an opening side of the first parasitic structure 14 may be away from the decoupling stub 13, and an opening side of the second parasitic structure 15 may be away from the decoupling stub 13. In FIG. 14, an opening side of the first parasitic structure 14 may face the decoupling stub 13, and an opening side of the second parasitic structure 15 may face the decoupling stub 13.

In addition, it should be noted that the U shape may alternatively be an approximate shape, and is limited to a U shape in a strict sense.

For example, as shown in FIG. 15, the first parasitic structure 14 is used as an example. A shape of the first parasitic structure 14 shown in FIG. 15 is a U shape in a strict sense.

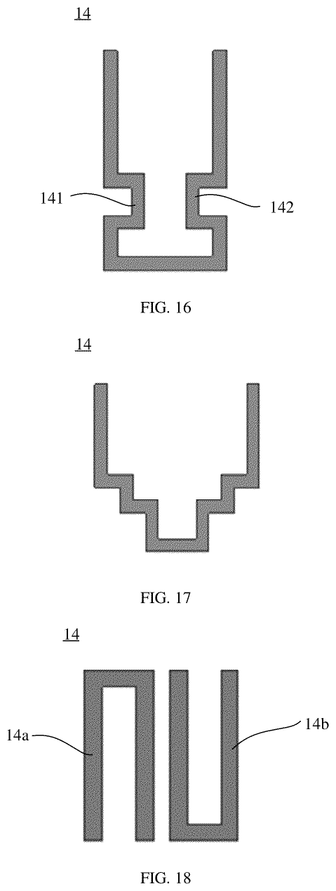

In addition, as shown in FIG. 16, in another example provided in this application, two opposite extension arms of the first parasitic structure 14 may have a part 141 and a part 142 that are close to each other.

Alternatively, as shown in FIG. 17, in another example provided in this application, a closed end of the first parasitic structure 14 may be converged in a stepped manner.

Certainly, in another example, the first parasitic structure 14, the second parasitic structure 15, and the third parasitic structure 18 may alternatively be in other shapes. Details are not described herein.

In addition, in actual application, each parasitic structure may alternatively include one U-shaped structure, or may include two, three, or even more U-shaped structures.

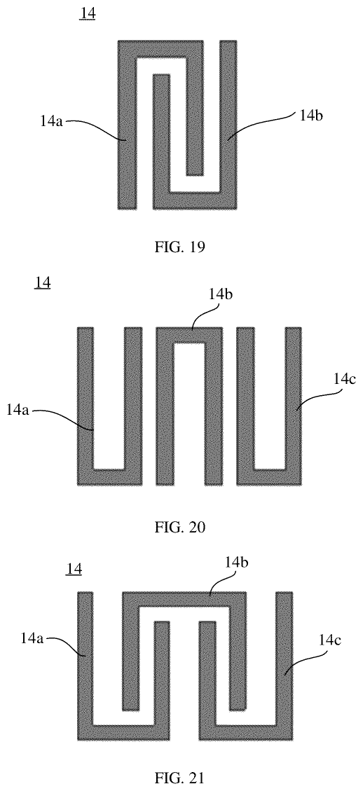

For example, as shown in FIG. 18 and FIG. 19, the first parasitic structure 14 is used as an example. The first parasitic structure 14 may include two parasitic bodies: a parasitic body 14a and a parasitic body 14b, and both the two parasitic bodies are of U-shaped structures.

In FIG. 18, the parasitic body 14a and the parasitic body 14b are spaced apart from each other, extension arms of the parasitic body 14a and the parasitic body 14b are parallel to each other, and directions of openings of the parasitic body 14a and the parasitic body 14b are opposite.

Alternatively, as shown in FIG. 19, in another example provided in this application, the parasitic body 14a and the parasitic body 14b are disposed in a cross manner, extension arms of the parasitic body 14a and the parasitic body 14b are parallel to each other, and directions of openings of the parasitic body 14a and the parasitic body 14b are opposite.

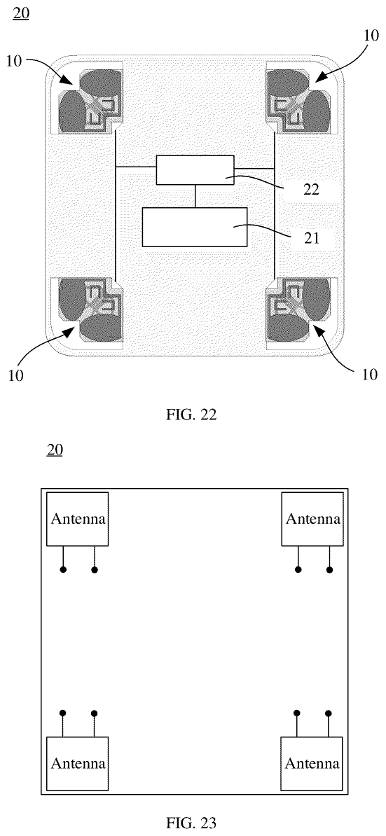

In addition, as shown in FIG. 20 and FIG. 21, the first parasitic structure 14 may include three parasitic bodies: a parasitic body 14a, a parasitic body 14b, and a parasitic body 14c, and the three parasitic bodies are all of U-shaped structures.

In FIG. 20, the parasitic body 14a, the parasitic body 14b, and the parasitic body 14c are sequentially spaced, extension arms of the parasitic body 14a, the parasitic body 14b, and the parasitic body 14c are parallel to each other, directions of openings of the parasitic body 14a and the parasitic body 14b are opposite, and directions of openings of the parasitic body 14a and the parasitic body 14c are the same.

Alternatively, as shown in FIG. 21, in another example provided in this application, the parasitic body 14a and the parasitic body 14c are spaced apart from each other, and the parasitic body 14b, the parasitic body 14a, and the parasitic body 14c are disposed in a cross manner.

It may be understood that, in actual application, a quantity, sizes, and a position layout of parasitic bodies included in the parasitic structure may be flexibly adjusted based on an actual requirement. Details are not described herein.

In addition, in actual application, the antenna 10 may be used in an indoor small base station, a router, a ceiling AP, a monitoring device, an internet of vehicles device, or another type of communication device.

For example, as shown in FIG. 22, a communication device 20 provided in an embodiment of this application may include a baseband unit 21, a radio HUB 22, and a plurality of antennas 10 (four antennas are shown in FIG. 22). The baseband unit 21 is connected to the radio HUB 22, and the plurality of antennas 10 are all connected to the radio HUB 22. The radio HUB 22 may be configured to receive downlink baseband data sent by the baseband unit 21, and transmit the downlink baseband data to different antennas 10 after splitting processing, and/or perform combination processing on uplink baseband data of different antennas 10, and send processed data to the baseband unit 21, to implement communication with the baseband unit 21.

As shown in FIG. 23, during specific disposing, the communication device 20 includes four antennas, and the four antennas may be respectively located at four corners of the communication device 20, to ensure that there is a sufficient distance between two adjacent antennas, so as to reduce coupling between adjacent antennas. This helps ensure performance of the communication device 20. Each antenna has two ports, and the four antennas have eight antenna ports in total, and therefore can form an 8T (channel) antenna system.

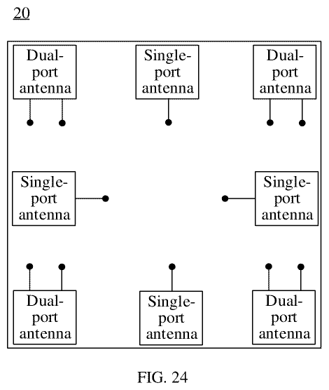

In addition, during specific implementation, the communication device may further include a conventional single-port antenna. For example, as shown in FIG. 24, the dual-port antenna in the figure is the antenna 10 provided in this embodiment of this application, and the single-port antenna is a conventional antenna including only one element in the industry. Each dual-port antenna has two ports, and four dual-port antennas have eight antenna ports in total. In addition, each single-port antenna has one port, and four single-port antennas have four antenna ports in total. Therefore, four dual-port antennas and four single-port antennas may form a 12T antenna system.

During specific disposing, the single-port antenna may be located between the dual-port antennas, so that a communication capacity of the communication device 20 can be effectively improved, and a size of the communication device 20 is not significantly increased.

Certainly, in specific application, a quantity, types, and a position layout of antennas included in the communication device 20 may be correspondingly adjusted based on an actual requirement. This is not limited in this application.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. An antenna, comprising:
a first element;
a second element;
a decoupling stub; a first parasitic structure; and
a second parasitic structure;
wherein a first end of the decoupling stub is connected to the first element, and a second end of the decoupling stub is connected to the second element;
wherein a first gap is disposed between the decoupling stub and the first element, and wherein a second gap is disposed between the decoupling stub and the second element; and
wherein the first parasitic structure is disposed in the first gap, and wherein the second parasitic structure is disposed in the second gap.

2. The antenna according to claim 1, wherein a length of the decoupling stub is 0.1 λ to 0.4 λ, and wherein a width of the decoupling stub is 0.2 mm to 4 mm; and
wherein λ is a wavelength corresponding to a lowest frequency within a relative operating frequency band range of the antenna.

3. The antenna according to claim 1, wherein the first gap or the second gap has a width of 0.01 λ to 0.15 λ; and
wherein λ is a wavelength corresponding to a lowest frequency within a relative operating frequency band range of the antenna.

4. The antenna according to claim 1, wherein the first parasitic structure comprises at least one U-shaped parasitic body, and wherein the second parasitic structure comprises at least one U-shaped parasitic body.

5. The antenna according to claim 1, wherein the first element and the second element are located in a rectangular contour, wherein the first element is located at a first corner in the rectangular contour, wherein the second element is located at a second corner in the rectangular contour, and wherein the first corner and the second corner are diagonally opposite;
wherein the first element has a first feed point, and wherein the first feed point is located in a first region of the first element, wherein the first region is a region whose circle center is the first corner and whose diameter is a largest axis of the first element; and
wherein the second element has a second feed point, and the second feed point is located in a second region of the second element, wherein the second region is a region whose circle center is the second corner and whose diameter is a largest axis of the second element.

6. The antenna according to claim 1, wherein the first element and the second element are located in a rectangular contour, wherein the first element is located at a first corner in the rectangular contour, wherein the second element is located at a second corner in the rectangular contour, and wherein the first corner and the second corner are diagonally opposite;
wherein the first element has a first ground point, wherein the first ground point is located in a first region of the first element, and wherein the first region is a region whose circle center is the first corner and whose diameter is a largest axis of the first element; and
wherein the second element has a second ground point, and wherein the second ground point is located in a second region of the second element, wherein the second region is a region whose circle center is the second corner and whose diameter is a largest axis of the second element.

7. The antenna according to claim 1, wherein the antenna further comprises a first feed line, a second feed line, and a third parasitic structure;
wherein the first feed line acts as a feed connection to the first element, the second feed line acts as a feed connection to the second element, and wherein a third gap is disposed between the first feed line and the second feed line; and
wherein the third parasitic structure is located in the third gap.

8. The antenna according to claim 7, wherein the third parasitic structure comprises at least one U-shaped parasitic body.

9. The antenna according to claim 7, wherein the antenna further comprises a first board body, a second board body, a third board body, and a fourth board body, wherein the first board body and the second board body are spaced apart from each other in parallel, and wherein the third board body and the fourth board body are connected between the first board body and the second board body;
wherein the first element, the second element, the decoupling stub, the first parasitic structure, and the second parasitic structure are located on the first board body;
wherein the first feed line, the second feed line, and the third parasitic structure are located on the second board body;
wherein the third board body has a first feed connection line, wherein a first end of the first feed connection line is connected to the first feed line, and wherein a second end of the first feed connection line is connected to the first element; and
wherein the fourth board body has a second feed connection line, wherein a first end of the second feed connection line is connected to the second feed line, and wherein a second end of the second feed connection line is connected to the second element.

10. A communication device, comprising:
a baseband unit;
a radio hub; and
one or more antennas;
wherein the baseband unit is connected to the radio hub, and the one or more of antennas are each connected to the radio hub;
wherein each antenna of the one or more antennas antenna comprises a first element and a second element, and further comprises a decoupling stub, a first parasitic structure, and a second parasitic structure;
wherein a first end of the decoupling stub is connected to the first element, and wherein a second end of the decoupling stub is connected to the second element;
wherein a first gap is disposed between the decoupling stub and the first element, and wherein a second gap is disposed between the decoupling stub and the second element; and
wherein the first parasitic structure is disposed in the first gap, and wherein the second parasitic structure is disposed in the second gap.

11. The communication device according to claim 10, wherein a length of the decoupling stub is 0.1 λ to 0.4 λ, and wherein a width of the decoupling stub is 0.2 mm to 4 mm; and
wherein λ is a wavelength corresponding to a lowest frequency within a relative operating frequency band range of the respective antenna.

12. The communication device according to claim 10, wherein the first gap or the second gap has a width of 0.01 λ to 0.15 λ; and
wherein λ is a wavelength corresponding to a lowest frequency within a relative operating frequency band range of the respective antenna.

13. The communication device according to claim 10, wherein the first parasitic structure comprises at least one U-shaped parasitic body, and wherein the second parasitic structure comprises at least one U-shaped parasitic body.

14. The communication device according to claim 10, wherein the first element and the second element are located in a rectangular contour, wherein the first element is located at a first corner in the rectangular contour, wherein the second element is located at a second corner in the rectangular contour, and wherein the first corner and the second corner are diagonally opposite;
wherein the first element has a first feed point, wherein the first feed point is located in a first region of the first element, and wherein the first region is a region whose circle center is the first corner and whose diameter is a largest axis of the first element; and
wherein the second element has a second feed point, wherein the second feed point is located in a second region of the second element, and wherein the second region is a region whose circle center is the second corner and whose diameter is a largest axis of the second element.

15. The communication device according to claim 10, wherein the first element and the second element are located in a rectangular contour, wherein the first element is located at a first corner in the rectangular contour, wherein the second element is located at a second corner in the rectangular contour, and wherein the first corner and the second corner are diagonally opposite;
wherein the first element has a first ground point, wherein the first ground point is located in a first region of the first element, and wherein the first region is a region whose circle center is the first corner and whose diameter is a largest axis of the first element; and
wherein the second element has a second ground point, wherein the second ground point is located in a second region of the second element, and wherein the second region is a region whose circle center is the second corner and whose diameter is a largest axis of the second element.

16. The communication device according to claim 10, wherein the antenna further comprises a first feed line, a second feed line, and a third parasitic structure;
wherein the first feed line acts as a feed connection to the first element, wherein the second feed line acts as a feed connection to the second element, and wherein a third gap is disposed between the first feed line and the second feed line; and
wherein the third parasitic structure is located in the third gap.

17. The communication device according to claim 16, wherein the third parasitic structure comprises at least one U-shaped parasitic body.

18. The communication device according to claim 16, wherein the each antenna of the one or more antennas comprises a first board body, a second board body, a third board body, and a fourth board body, wherein the first board body and the second board body are spaced apart from each other in parallel, and wherein the third board body and the fourth board body are connected between the first board body and the second board body;
wherein the first element, the second element, the decoupling stub, the first parasitic structure, and the second parasitic structure are located on the first board body;
wherein the first feed line, the second feed line, and the third parasitic structure are located on the second board body;
wherein the third board body has a first feed connection line, wherein a first end of the first feed connection line is connected to the first feed line, and wherein a second end of the first feed connection line is connected to the first element; and
wherein the fourth board body has a second feed connection line, wherein a first end of the second feed connection line is connected to the second feed line, and wherein a second end of the second feed connection line is connected to the second element.
